(19) United States
(12) Patent Application Publication
(10) Pub. No.: US 2004/0141080 A1
(43) Pub. Date: Jul. 22, 2004

(54) User interface method and apparatus for a digital imaging device having multiple operating modes

(76) Inventor: Amy E. Battles, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/349,383

(22) Filed: Jan. 21, 2003

(51) Int. Cl. H04N 5/222

(52) U.S. Cl. 348/333.01

(57) ABSTRACT

A user interface for a digital imaging device having multiple operating modes organizes menu options for the various operating modes into a single menu comprising multiple mode views, one for each operating mode. The display of the device may be scrolled seamlessly from one mode view with its associated menu option icons to another mode view with its associated menu option icons, allowing a user to access easily any desired mode view or menu option.

### FIELD OF THE INVENTION

The present invention relates generally to digital imaging devices and more specifically to user interfaces for digital imaging devices having multiple operating modes.

### BACKGROUND OF THE INVENTION

Digital imaging devices such as digital still cameras and digital camcorders typically have multiple operating modes, each of which may have its own menu for setting options within that particular mode. For example, some digital still cameras have three distinct operating modes, each with its own menu: general settings, capture (or “live preview”), and playback. In the general settings mode, settings affecting the general operation of the digital still camera (e.g., date, time, sound options) may be adjusted. In the capture mode, the digital still camera presents a rapidly updated video preview of the current scene prior to an image being captured and saved to memory. In the playback mode, the digital still camera displays images already captured and stored in the device's memory.

Usability testing has shown that users find digital imaging devices with multiple menus difficult to use. One reason is that the user can easily lose track of which mode/menu he or she is in and end up looking for menu options that are in a different menu. Once the user realizes he or she is in the wrong menu, it is necessary to exit the current mode/menu and switch to another mode/menu to find the desired menu option. Some digital imaging devices attempt to solve this problem by including all available options and features for all operating modes in a single menu. However, the options associated with the various modes are mixed together in such a way that it is not clear to the user which command goes with which operating mode.

It is thus apparent that there is a need in the art for an improved user interface for digital imaging devices having multiple operating modes.

### SUMMARY OF THE INVENTION

A digital imaging device user interface method is provided. An apparatus for carrying out the method is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A is a functional block diagram of a digital imaging device in accordance with an illustrative embodiment of the invention.

FIG. 1B is an illustration of the display and the input controls of the digital imaging device shown in FIG. 1A in accordance with an illustrative embodiment of the invention.

FIG. 2A is a conceptual diagram of a menu system in a vertical orientation in accordance with an illustrative embodiment of the invention.

FIG. 2B is a conceptual diagram of a menu system in a horizontal orientation in accordance with another illustrative embodiment of the invention.

FIG. 3A is a flowchart of the operation of the digital imaging device shown in FIG. 1A in accordance with an illustrative embodiment of the invention.

FIG. 3B is a flowchart of the operation of the digital imaging device shown in FIG. 1A in accordance with another illustrative embodiment of the invention.

### DETAILED DESCRIPTION OF THE INVENTION

The user interface of a digital imaging device having multiple operating modes may be improved as follows. First, a single menu may be organized such that each operating mode has its own mode view on the device display. Secondly, the user interface may be configured to scroll the single menu seamlessly from one mode view with its associated menu option icons to another mode view with its associated menu option icons.

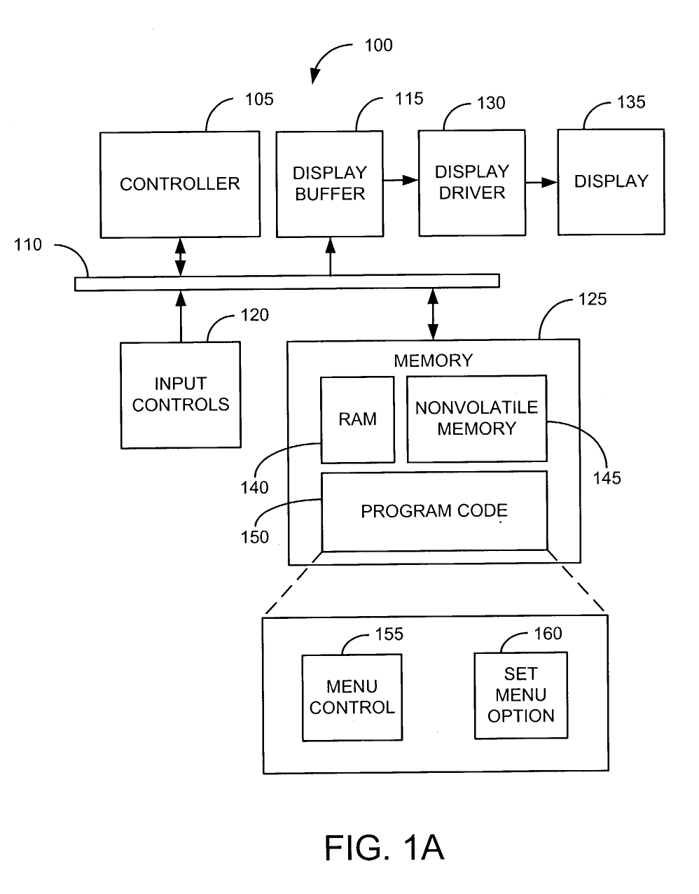

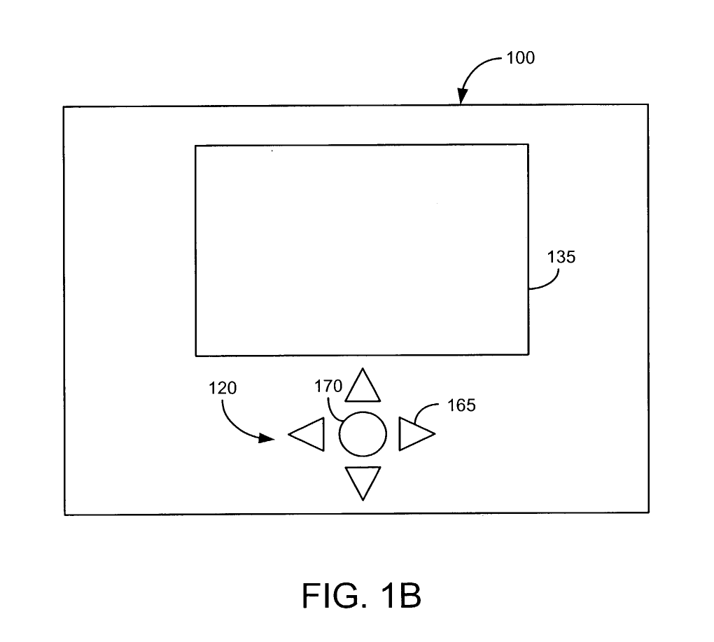

FIG. 1A is a functional block diagram of a digital imaging device 100 in accordance with an illustrative embodiment of the invention. Digital imaging device 100 may be, for example, a digital still camera, a digital camcorder, or any other device capable of capturing, storing, and displaying digital images. In FIG. 1A, controller 105 communicates over data bus 110 with display buffer 115, input control 120, and memory 125. The output of display buffer 115 is fed to display driver 130, which in turn drives display 135. Display buffer 115 is configured to receive image data associated with multiple operating modes of digital imaging device 100 to form a composite image on display 135. For example, display buffer 115 may contain a composite image comprising a portion of the playback-mode mode view and a portion of the capture-mode mode view, allowing a portion of each mode view to be viewed simultaneously on display 135. Display buffer 115 is also configured to scroll display 135 seamlessly from one mode view with its associated icons to another mode view with its associated icons.

Memory 125 may further comprise random access memory (RAM) 140, nonvolatile memory 145, and program code 150. One or more digital images may be stored in nonvolatile memory 145, which may be of the removable variety. In one embodiment, controller 105 comprises a microprocessor or microcontroller, and program code 150 comprises stored program instructions executed by controller 105. For example, program code 150 may reside in firmware. In general, the logic contained in program code 150 may be implemented in firmware, software, custom hardware, or any combination thereof. Program code 150 may comprise Module Menu Control 155 and Module Set Menu Option 160. Module Menu Control 155 controls the overall operation of the user interface. For example, Module Menu Control 155 may control the displaying of icons in each mode view and the writing of data to display buffer 115 to perform operations such as scrolling among the various mode views. Module Set Menu Option 160 sets a menu option, possibly calling up a sub-menu, in response to the icon representing a particular menu option being selected.

FIG. 1B is an illustration of one possible implementation of input controls 120 in accordance with an illustrative embodiment of the invention. FIG. 1B depicts digital imaging device 100 with display 135 and input controls 120. In this particular implementation, input controls 120 comprise four directional buttons 165 and a center “Menu/OK” button 170. In this embodiment, Menu/OK button 170 may be used both to select menu option icons when the menu is on and to turn the menu itself on and off. In another embodiment, a separate “menu” button (not shown in FIG. 1B) may instead be used to turn the menu on and off. In the applicable context, Menu/OK button 170 also selects the icon in the menu that currently has focus (e.g., highlighted or shown in reverse video), and Module Set Menu Option 160 sets the associated option or calls up the associated sub-menu. A user may use directional buttons 165 as navigational controls to access various features of digital camera 100. In some embodiments, a pair of opposing directional buttons (up/down or left/right) acts as the navigational control. For example, the up/down buttons may be used to switch among operating modes (e.g., capture mode, playback mode, or general settings). The left/right buttons may be used, for example, to scroll between images when digital imaging device 100 is in playback mode. Many other implementations of input controls 120 are possible. For example, the navigational control may instead comprise a single four-way rocking button, a mini-joystick, or any other input control capable of signaling directions. In yet another embodiment, two rather than four directional buttons 165 may be used. Likewise, the functions provided by Menu/OK button 170 may also be implemented differently in other embodiments. For example, depending on context, a navigational control 165 may double as a “menu” button to activate or deactivate the menu or as an “OK” button to select menu options. This technique of assigning multiple uses to a single directional button 165 is, however, more readily implemented in embodiments including four directional buttons 165.

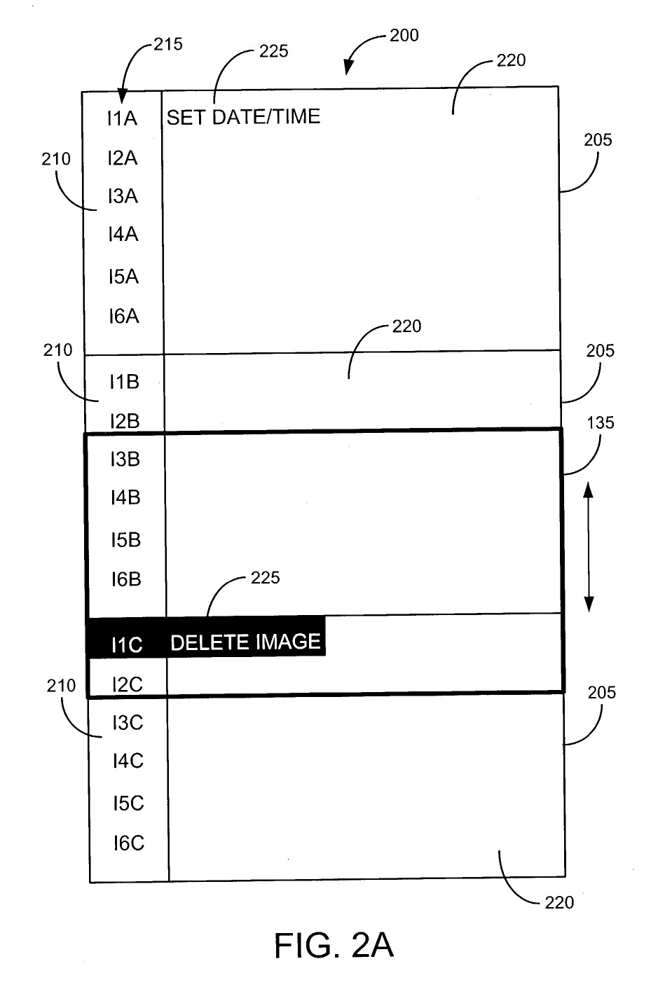

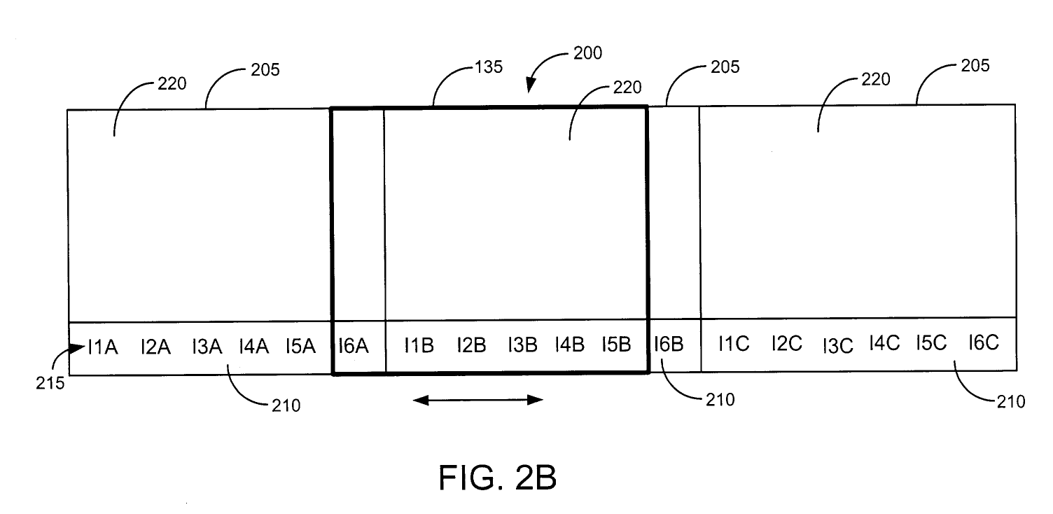

FIG. 2A is a conceptual diagram of a menu system 200 in a vertical orientation in accordance with an illustrative embodiment of the invention. In FIG. 2A, menu system 200 is organized such that each of three operating modes in digital imaging device 100 has its own mode view on display 135, each mode view having its own icons representing menu options that are available in that operating mode. In other embodiments, more or fewer operating modes than three may exist in digital imaging device 100. In the example of FIG. 2A, each of general settings mode, capture mode, and playback mode has an associated mode view 205 comprising a menu 210 with one or more icons 215 (icon sets I1A-I6A, I1B-I6B, and I1C-I6C, respectively). Each icon 215 represents a menu option within the associated mode view 205. Each mode view 205 also includes a background region 220 that differs in function with operating mode. In general settings mode, background region 220 may be blank, for example. In capture mode, background region 220 may show a rapidly updated video view (e.g., 30 frames/sec.) of the current scene prior to image capture. In playback mode, background region 220 may comprise a previously captured digital image stored in RAM 140 or nonvolatile memory 145. Icons 215 or textual prompts such as 225 may overlay the background region 220 of a mode view 205, as illustrated in FIG. 2A.

In response to a navigational control such as up/down buttons 165, Module Menu Control 155 may scroll menu system 200 by one icon 215. In the example shown in FIG. 2A, display 135 (heavy rectangle) shows a portion of mode view 205 for playback mode and a portion of mode view 205 for capture mode simultaneously. Scrolling may thus occur seamlessly across mode views 205. Optionally, scrolling beyond a given mode view 205 may cause display 135 to “jump” to a complete view of the next mode view 205 instead of a portion of the two mode views 205 being shown simultaneously. At any given time, one icon 215 “has focus.” In FIG. 2A, icon I1C and its associated text prompt, “Delete Image,” in the playback menu 210 (bottom mode view 205 in FIG. 2A) has focus (shown in reverse video in FIG. 2A).

FIG. 2A is purely a conceptual diagram to clarify the operation of this illustrative embodiment. In an actual implementation, only the data shown within the rectangle representing display 135 need be stored in display buffer 115 at any one time. If menu system 200 is scrolled to either extremity, it may either stop there, perhaps signaling the user with an audible tone, or menu 200 may “wrap around.” For example, scrolling upward when icon I1A already has focus may cause display 135 to wrap around to the mode view 205 associated with playback mode (bottom mode view in FIG. 2A). That is, icon I6C would have focus (be highlighted).

FIG. 2B is a conceptual diagram of a menu system in a horizontal orientation in accordance with another illustrative embodiment of the invention. In FIG. 2B, icons 215 are arranged horizontally across the bottom of each background region 220 instead of being arranged vertically as in FIG. 2A. In other respects, the operation of menu system 200 is analogous to that shown in FIG. 2A. In this particular embodiment, the navigational control may, for example, comprise left/right directional buttons 165.

In carrying out the seamless icon-by-icon scrolling across mode views illustrated in FIG. 2A, Module Menu Control 155 may determine what portion of display 135 should be occupied by each applicable mode view 205 as display 135 is scrolled in response to directional buttons 165. Module Menu Control 155 may then control the writing of still image or video data in the applicable proportions to display buffer 115. In doing so, Module Menu Control 155 acquires image or video data from multiple sources (e.g., an image stored in nonvolatile memory 145 or video from live preview mode). In the example shown in FIG. 2A, Module Menu Control 155 may control the writing to display buffer 115 of (1) the top portion of a playback image and icons I1C and I2C from the associated mode view 205 and (2) the bottom portion of the live video preview and icons 13B-16B from the associated mode view 205. Such techniques for controlling a display buffer receiving data from multiple image or video sources are well known in the video display art.

It is advantageous for the icons 215 associated with a particular mode view 205 to be a different color from those of other mode views 205 or to differ visually in some other way. In FIG. 2A, for example, the icons 215 in each set of icons (I1A-I6A, I1B-I6B, and I1C-I6C) may be a different color.

Although FIGS. 2A and 2B show only six icons in each mode view 205, there may be more icons in a particular mode view 205 than can be displayed at one time on display 135. In this case, the icons 215 may scroll separately from background region 220 to allow a user to access all the available icons in that mode view 205. If an attempt is made to scroll beyond the first or the last icon 215 in a mode view 205, display 135 may be scrolled to show all or a portion of another mode view 205, as described above.

To promote greater consistency and intuitiveness in the user interface, directional buttons 165 (e.g., up/down) may also be used to switch operating modes in digital imaging device 100 even when menu system 200 is turned off. This optional feature is consistent with the seamless mode switching that occurs when a user scrolls among the various mode views 205 when menu system 200 is turned on. In one embodiment, scrolling to a particular mode view 205 causes digital imaging device 100 to remain in the corresponding operating mode when menu system 200 is turned off. In an alternative embodiment, when menu system 200 is turned off, digital imaging device 100 returns to the operating mode that was in effect when menu system 200 was turned on, regardless of which mode view 205 was displayed when menu system 200 was turned off.

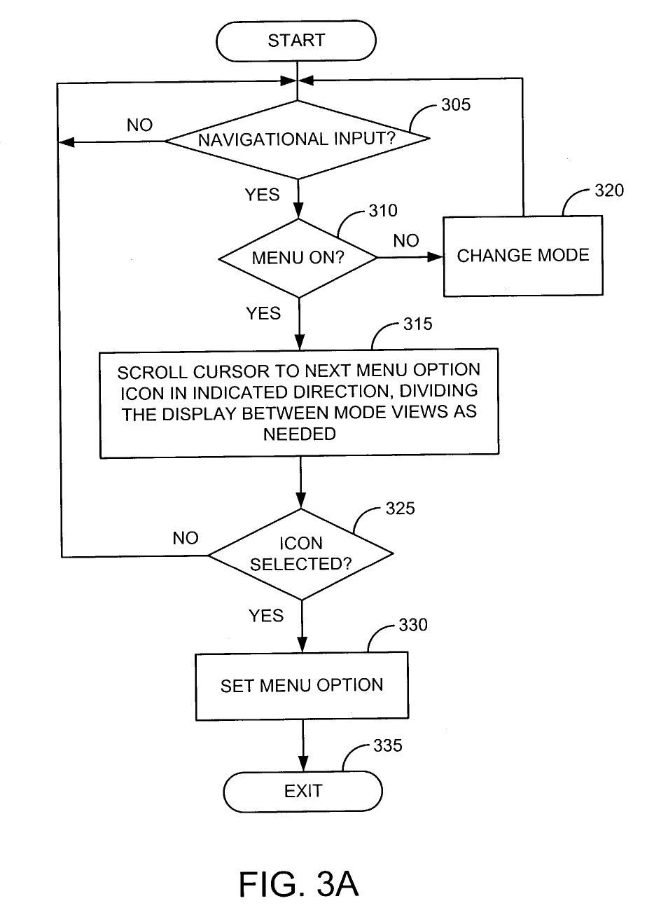

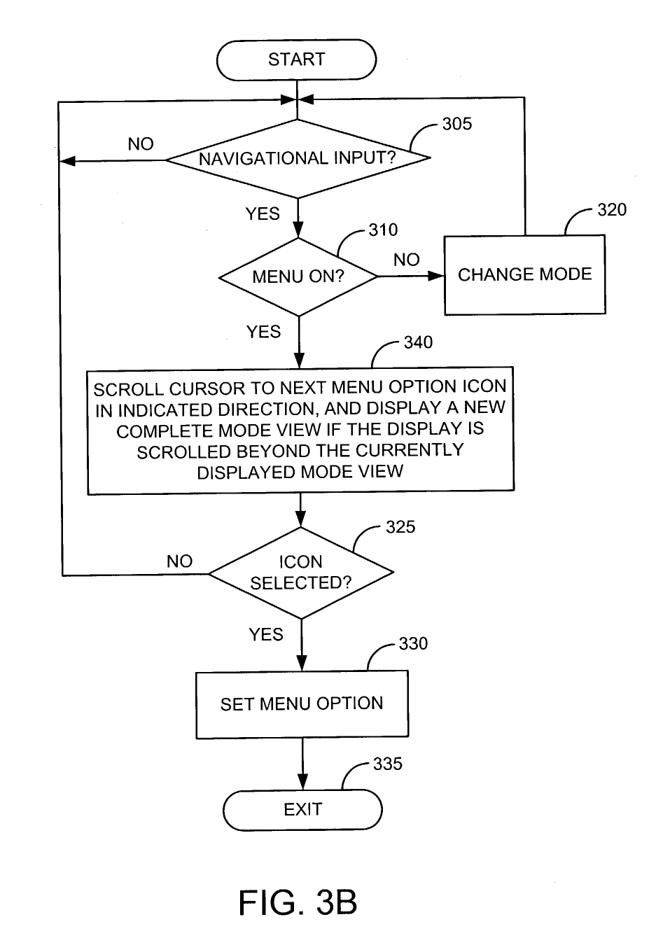

FIG. 3A is a flowchart of the operation of digital imaging device 100 in accordance with an illustrative embodiment of the invention. If a navigational input is received at 305, control proceeds to 310. If menu system 200 is turned on at 310, control proceeds to 315. Otherwise (if menu system 200 is turned off at 310), the operating mode of digital imaging device 100 may be changed at 320, and control returns to 305. At 315, Module Menu Control 155 scrolls display 135 to give focus to the next icon 215 in the direction indicated by the navigational input received at 305. If necessary, display 135 is divided between mode views 205 as described above. If the icon 215 currently having focus is selected (e.g., Menu/OK button 170 is pressed) at 325, the menu option that icon 215 represents is set by Module Set Menu Option 160 at 330. The process terminates at 335.

FIG. 3B is a flowchart of the operation of digital imaging device 100 in accordance with another illustrative embodiment of the invention. The method shown in FIG. 3B is similar to that in FIG. 3A, except that, at 340, display 135 is scrolled to show an entire mode view 205 when display 135 is scrolled beyond the current mode view 205. For example, in FIG. 2A, scrolling from highlighted icon I1C to icon I6B causes Module Menu Control 155 to display all of the mode view 205 associated with icons I1B-I6B, icon I6B being highlighted. In this particular embodiment, there is no need to divide display 135 among multiple mode views 205 because display 135 “jumps” to a complete mode view 205 whenever display 135 is scrolled beyond the currently displayed mode view 205.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for visually displaying on a display of a digital imaging device a choice of operating modes and menu options associated with the operating modes, each operating mode having a mode view, each menu option being represented by an icon, the method comprising:
scrolling the display from one mode view and its associated icons to another mode view and its associated icons; and
selecting a menu option by selecting the icon that represents the menu option.

2. The method of claim 1, wherein the icons associated with each mode view are a distinct color.

3. The method of claim 1, wherein the icons are arranged in a vertical column.

4. The method of claim 1, wherein the icons are arranged in a horizontal row.

5. The method of claim 1, wherein the icons associated with each mode view partially overlay a background scene associated with that mode view.

6. The method of claim 1, wherein a mode view has more associated icons than can be displayed at one time, and the icons associated with that mode view are capable of scrolling separately from a background scene associated with that mode view.

7. The method of claim 1, wherein the display shows a new complete mode view when the display is scrolled beyond a currently displayed mode view.

8. The method of claim 1, wherein one of the operating modes is a live preview mode in which the digital imaging device presents a video preview of a scene prior to an image being captured.

9. The method of claim 1, wherein one of the operating modes is an image playback mode in which a previously captured image is shown on the display.

10. The method of claim 1, wherein one of the operating modes is a general settings mode in which settings affecting the general operation of the digital imaging device can be adjusted.

11. The method of claim 1, wherein the digital imaging device is one of a digital still camera and a digital camcorder.

12. A user interface to display visually on a display of a digital imaging device a choice of operating modes and menu options associated with the operating modes, each operating mode having a mode view, each menu option being represented by an icon, the user interface comprising:
a navigational control;
a display buffer configured to scroll the display from one mode view and its associated icons to another mode view and its associated icons in response to the navigational control; and
a selection control configured to select a menu option, when the icon representing that menu option is selected.

13. The user interface of claim 12, wherein the navigational control comprises a pair of opposing directional buttons.

14. The user interface of claim 12, wherein the icons are turned off, but the navigational control still selects the operating mode of the digital imaging device.

15. The user interface of claim 12, wherein the display buffer is configured to display a new complete mode view when the display is scrolled beyond a currently displayed mode view.

16. The user interface of claim 12, wherein the digital imaging device comprises one of a digital still camera and a digital camcorder.

17. The user interface of claim 12, wherein one of the operating modes is a live preview mode in which the digital imaging device presents a video preview of a scene prior to an image being captured.

18. The user interface of claim 12, wherein one of the operating modes is an image playback mode in which a previously captured image is shown on the display.

19. The user interface of claim 12, wherein one of the operating modes is a general settings mode in which settings affecting the general operation of the digital imaging device can be adjusted.

20. A user interface to display visually on a display of a digital imaging device a choice of operating modes and menu options associated with the operating modes, each operating mode having a mode view, each menu option being represented by an icon, the user interface comprising:
means for navigating the display;
means for scrolling the display from one mode view and its associated icons to another mode view and its associated icons in response to the means for navigating the display; and
means for selecting a menu option, when the icon representing that menu option is selected.

21. The user interface of claim 20, wherein the means for navigating the display comprises a pair of opposing directional buttons.

22. The user interface of claim 20, wherein the icons are turned off, but the means for navigating the display still selects the operating mode of the digital imaging device.

23. The user interface of claim 20, wherein the means for scrolling the display is configured to display a new complete mode view when the display is scrolled beyond a currently displayed mode view.

24. The user interface of claim 20, wherein the digital imaging device comprises one of a digital still camera and a digital camcorder.
